(19) United States
(12) Patent Application Publication
(10) Pub. No.: US 2004/0057152 A1
(43) Pub. Date: Mar. 25, 2004

(54) Disk drive

(75) Inventor: Youichi Konno, Tokorozawa-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: PIONEER CORPORATION, Tokyo (JP)

(21) Appl. No.: 10/659,395

(22) Filed: Sep. 11, 2003

(30) Foreign Application Priority Data
Sep. 19, 2002 (JP) 2002-273588

(51) Int. Cl. G11B 17/00

(52) U.S. Cl. 360/97.01

(57) ABSTRACT

A disk drive includes a main unit and an outer case (2). The main unit includes a disk-driving unit for rotating a disk, a data-reproducing unit for reproducing data from the disk, and a drive unit for moving the data-reproducing unit relative to the disk. The outer case (2) has a top wall (3a) and a rear wall (3c). The top wall (3a) opposes the main unit. The rear wall (3c) extends from the rear edge of the top wall (3a), is gently inclined and covers the rear part of the main unit. The rear wall (3c) serves as a guide when the disk drive is inserted into a slot of an apparatus. In addition, the metal plate used to form the outer case (2) can be smaller than otherwise.

### BACKGROUND OF THE INVENTION

1. Field of the Invention

The present invention relates to a disk drive that includes a main unit and an outer case covering the main unit.

2. Description of Related Art

Disk drives for reproducing or reproducing/recording data from and on optical disks such as DVDs (Digital Versatile Disks) and CDs (Compact Disks) have been widely used. A disk drive having such a structure as shown in FIG. 1 is known.

The disk drive 101 illustrated in FIG. 1 has an outer case 102 that is made of metal, shaped like a box and open at one side. The outer case 102 contains a frame 103 that is made of synthetic resin.

The frame 103 holds a disk-driving unit, a data-reproducing unit and a main unit. The disk-driving unit (not shown) is designed to rotate an optical disk. The data-reproducing unit (not shown) has a photosensor for recording or reproducing data on or from the optical disk. The main unit has a drive unit for moving the data-reproducing unit relative to the optical disk.

A disk tray (not shown) is arranged in the frame 103 and near the open side of the outer case 102 where the optical disk is mounted thereon. The disk tray can move into and out from the open side of the outer case 102. Connectors 104 are provided on that side of the outer case 102, which opposes the open side where the disk tray is disposed.

Cables (not shown) for supplying power and signals to the disk drive 101 from external apparatuses and vice versa are detachably connected to the connectors 104. The connectors 104 of different types are arranged side by side.

The outer case 102 includes a lower case 105, an upper case 106, and a decorative panel 107. The upper case 106 mounted on the lower case 105 with length L1, width L2 and height L3 includes a top wall 106a, two side walls 106b, a rear wall 106c, and a panel-holding strip 106d. The side walls 106b extend downwards from two long edges of the top wall 106a, thus at right angles to the top wall 106a. The rear wall 106c extends downwards from the rear edge of the top wall 106a, thus at right angles to the top wall 106a. The rear wall 106c has a width L4. The panel-holding strip 106d holds the decorative panel 107.

Data items about the connectors 104 (e.g., the types of the cables that are to be connected to the connectors 104) are indicated on the rear wall 106c.

The lower case 105 and upper case 106 which are made of metal to acquire sufficient heat resistance are formed by cutting a rectangular metal plate and bending the plate at prescribed positions.

The upper case 106, for example, has been formed by cutting and bending such a rectangular plate as is shown in FIG. 2. More precisely, the rectangular plate cut has a vertical dimension M1 (M1=L1+L2+L5; note that L5 is a margin for the panel-holding strip 106d) and a horizontal dimension M2 (M2=2×L3+L2). This plate is bent along the dashed lines for forming the upper case 106.

In the disk drive 101 as shown in FIG. 1, the upper case 106 is formed by bending some parts of a metal plate cut in a specific profile, at right angles to the major part (i.e., the part to become top wall 106a). Inevitably, the metal plate for the top wall 106a becomes large, thereby increasing the manufacturing cost of the disk drive 101.

The upper case 106 cannot be made smaller, however, for two reasons. First, the sizes of the top wall 106a and side walls 106b are determined by the length, width and height of the main unit. Second, the width of the rear wall 106c is determined by the area in which the data items about the connectors 104 are indicated.

Further, the disk drive 101 cannot be smoothly inserted into other apparatuses, for example, a tower-type computer through a slot made in one side of the computer from the side of the connectors 104 of the disk drive 101. This is because the top wall 106a and rear wall 106c of the upper case 106 form a right-angled corner with a shape edge, which may abut on the edges of the slot.

### SUMMARY OF THE INVENTION

An object of the present invention is to provide a disk drive that can be manufactured at a low cost and can easily be inserted into any other apparatus.

A disk drive according to the present invention includes a main unit and an outer case. The main unit includes a disk-driving unit for rotating a disk, a data-reproducing unit for reproducing data from the disk, and a drive unit for moving the data-reproducing unit relative to the disk. The outer case has a horizontal plate opposing the main unit and an inclined plate. The inclined plate extending from a rear edge of the horizontal plate is gently inclined and covers the rear part of the main unit.

### BRIEF DESCRIPTION OF THE DRAWINGS

FIG. 1 is a perspective view, representing an outer appearance of a disk drive according to a conventional example;

FIG. 2 is a development view of an upper case that constitutes an outer case of the disk drive according to the conventional example;

FIG. 3 is an exploded perspective view of a disk drive according to an embodiment of the present invention;

FIG. 4 is a perspective view, representing an outer appearance of the disk drive according to the embodiment;

FIG. 5 is a development view of an upper case that constitutes an outer case of the disk drive according to the embodiment;

FIG. 6A is a cross-sectional view illustrating the primary portion of the disk drive according to the embodiment; and

FIGS. 6B and 6C are cross-sectional views showing the modifications of the disk drive according to the embodiment.

### DETAILED DESCRIPTION OF PREFERRED EMBODIMENT(S)

An embodiment of the present invention will be described, with reference to the accompanying drawings.

[Arrangement of Disk Drive]

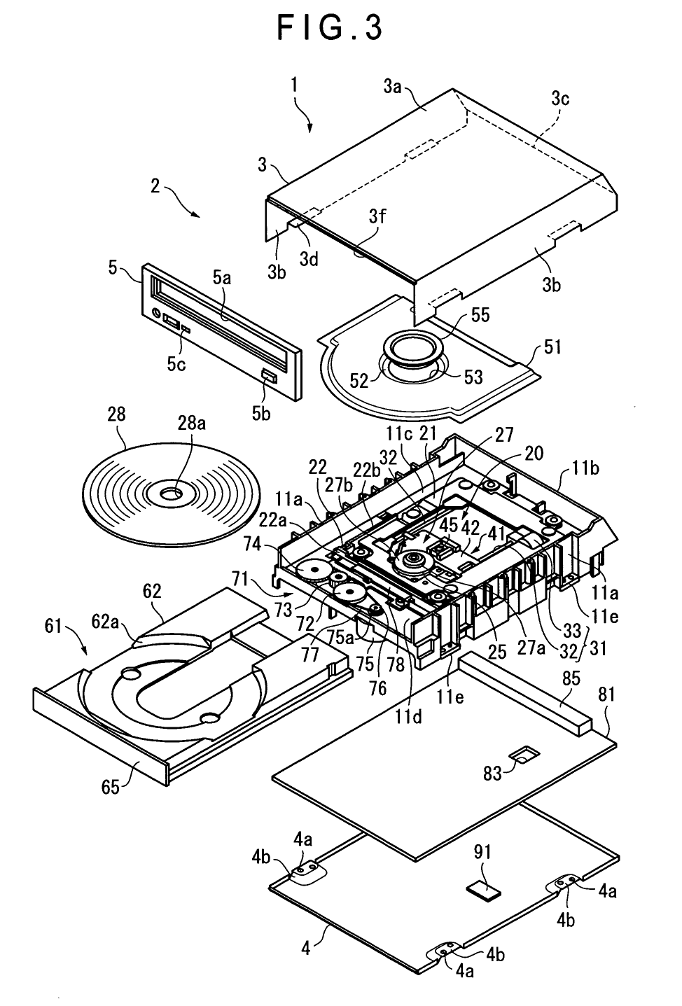

FIG. 3 is an exploded perspective view of a disk drive according to an embodiment of the present invention.

As FIG. 3 shows, a disk drive 1 has a main unit 20 and an outer case 2. The outer case 2 covers the main unit 20.

The outer case 2 includes an upper case 3, a lower case 4, and a decorative panel 5. The upper case 3 is made of metal and opens at the bottom and the front. The lower case 4 is made of metal and closes the bottom of the upper case 3. The decorative panel 5 is made of synthetic resin and closes the front of the upper case 3.

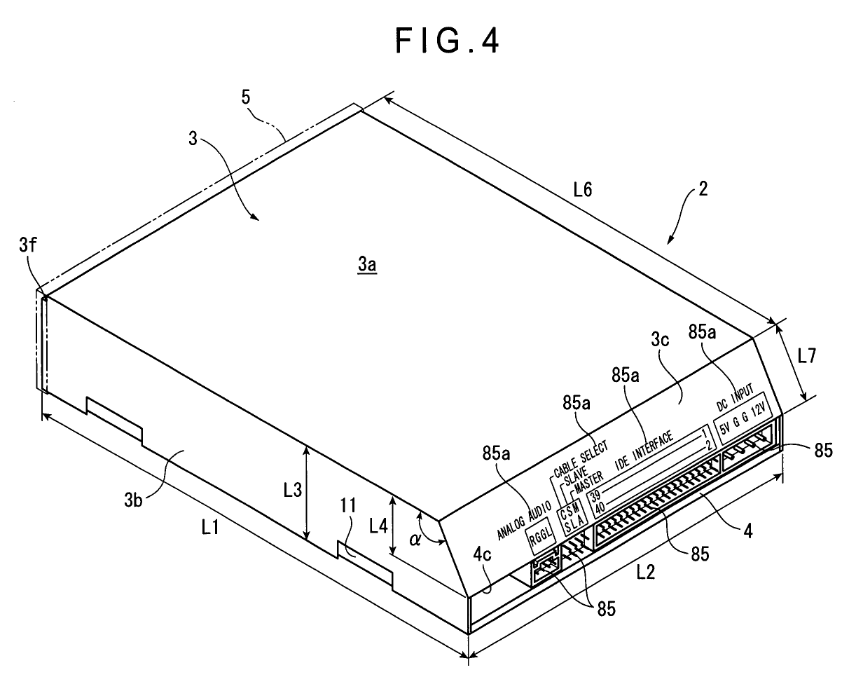

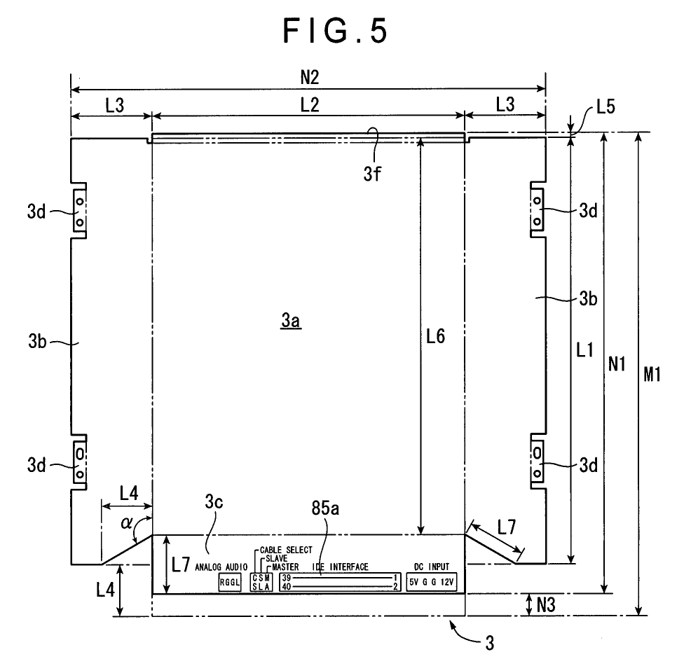

FIG. 4 is a perspective view of the disk drive 1, and FIG. 5 is a development view of the upper case 3.

As seen from FIGS. 4 and 5, the upper case 3 is composed of a top wall 3a (horizontal plate), two side walls 3b, a rear wall 3c (inclined plate), and a panel-holding strip 3f. The side walls 3b extends downwards from the long edges of the top wall 3a, namely at almost right angles to the side wall 3b. The rear wall 3c extends from the rear edge of the top wall 3a and is inclined at an obtuse angle α to the top wall 3a. The panel-holding strip 3f holds the decorative panel 5. The upper case 3 opens at the bottom and the front.

The top wall 3a opposes the main unit 20. It is a rectangular plate that has length L6 and width L2.

The side walls 3b have an upper edge and a lower edge, which have length L6 and length L1, respectively. The side walls 3b have height L3. The rear wall 3c has width L7 and length L2.

The angle α is an obtuse angle (90°<α<180°). The angle α can be of any value that falls within the range. Preferably, it is greater than 120° and less than 150° (120°<α<150°).

Since the rear wall 3c is inclined at angle α to the top wall 3a, those edges of the side walls 3b which meet the rear wall 3c are inclined, too.

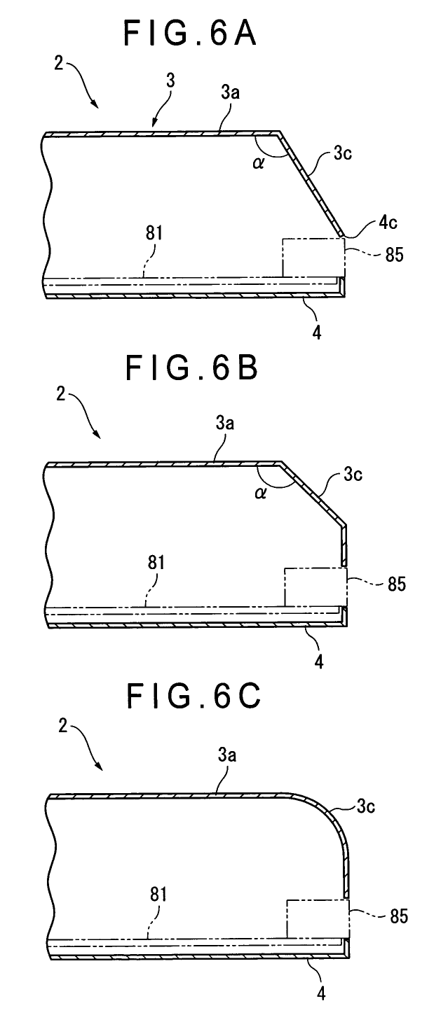

The rear wall 3c is a flat plate. Its height, or the distance between its lower edge and the top wall 3a, is L4. An opening 4c is made between the rear wall 3c and the lower case 4 (see FIG. 6A).

Some parts on a lower-edge of either side wall 3b of the upper case 3, for example two lower-edge parts, are bent inwards, forming fastening strips 3d. The fastening strips 3d have screw holes (not shown) each.

The rear wall 3c has a plurality of approximately slit-shaped exhaust ports (not shown) cut in the middle part.

The top wall 3a, the side walls 3b, the rear wall 3c, the fastening strips 3d and the panel-holding strip 3f have been formed by bending metal plates that have specific shapes as illustrated in FIG. 5.

As FIG. 3 depicts, the lower case 4 is a rectangular plate that is almost identical to the upper case 3 in shape.

The lower case 4 has fastening tabs 4b at either long side. The tubs 4b have been formed by bending upward two edge parts of a rectangular plate corresponding to the fastening strip 3d of the upper case 3. Each fastening tab 4b has two projected screw holes 4a.

The lower case 4 is formed by cutting a rectangular metal plate and bending the four edges of the plate. The lower case 4 is shaped like a rectangular plate. A heat-radiating member 91 is fixed to the inner surface of the lower case 4. The heat-radiating member 91 is made of material, such as silicone rubber, which is thermally conductive, electrically insulating and sufficiently elastic. The heat-radiating member 91 is positioned in alignment with an electric component 82 of a circuit board 81, which will be described later.

The decorative panel 5 is shaped like a plate. It is made of synthetic resin such as acrylonitrile-butadiene-styrene (ABS). Engagement claws (not shown) protrude almost vertically from the decorative panel 5 that are detachably attached in engagement with the lower case 4 and the side walls 3b of the upper case 3.

The decorative panel 5 has a rectangular window 5a that extend horizontally in longitudinal direction. A switch 5b and operation indicators 5c are mounted on the decorative panel 5.

A frame 11 is provided in the outer case 2. The frame 11 is made of synthetic resin, such as ABS, which is rigid and electrically insulating.

The frame 11 includes two side walls 11a, a rear wall 11b, two support ribs 11c, and a shutter drive-holding rib 11d so as forming approximately rectangular frame with both end surfaces opening in axial direction. The side walls 11a contact the inner surfaces of the side walls 3b of the upper case 3. The rear wall 11b contacts the inner surface of the rear wall 3c of the upper case 3. The support ribs 11c are strips, each extending inwards from one side wall 11a and connected at one end to the rear wall 11b. The shutter drive-holding rib 1d is located, bridging those ends of the side walls 11a which face away from the rear wall 11b.

Fastening ribs 11e are provided on each side wall 11a of the frame 11. The fastening ribs 11e are held, each between one fastening strip 3d of the upper case 3 and one fastening tab 4b of the lower case 4. The fastening ribs 11e are fastened to the upper case 3 and lower case 4 with screws.

The frame 11 holds the main unit 20. The main unit 20 has a base 21 that is a frame made of, for example, metal.

A rotation-transmitting section 22 is integrally fastened to one edge of the base 21. The rotation-transmitting section 22 has a holding member 22a and a pair of arms 22b. The holding member 22a is an elongated strip that extends along that edge of the base 21. The base 21 is integrally fastened to the holding member 22a with screws. The pair of arms 22b are formed integral with the holding member 22a and project almost perpendicularly from the ends of the holding member 22a. The arms 22b are rotatably supported by the support ribs 11c that extend from the side wall 11a of the frame 11. The section 22 transmits rotation to the base 21.

A disk-driving unit 25 is mounted on the free end of the base 21. The disk-driving unit 25 includes an electric motor for rotation (not shown) and a turntable 27. The electric motor is, for example, spindle motor. The turntable 27 is coupled to the output shaft of the electric motor.

The turntable 27 has a columnar shaft 27a and a flange 27b. The shaft 27a can pass through a shaft hole 28a made in the center part of an optical disk 28. The flange 27b is projected from an outer circumference of the shaft 27a and can support the center part of the optical disk 28. A magnet (not shown) is embedded in the distal end of the shaft 27a of the turntable 27.

A drive unit 31 is arranged on the base 21. The drive unit 31 includes a pair of guide shafts 32 and an electric motor 33.

The pair of guide shafts 32 are fastened at one end to the base 21 and extend horizontally toward the rotation-transmitting section 22. The electric motor 33 is positioned with the output axis direction thereof extending along the axis direction of the guide shafts 32. The output shaft of the electric motor 33 has a helical groove (not shown) cut in its circumferential surface.

The drive unit 31 holds a data-reproducing unit 41. The data-reproducing unit 41 has a carriage 42 that is mounted at ends on the guide shafts 32 of the drive unit 31. The carriage 42 holds a light source (not shown), a lens 45 and a photosensor (not shown). The lens 45 focuses a light beam emitted from the light source. The photosensor detects a light beam reflected by the optical disk 28.

A rotor support 51 is fastened to the frame 11 with screws, bridging the side walls 11a of the frame 11. The rotor support 51 is, for example, a metal plate.

The rotor support 51 has a circular recess 52 made in its approximately center part. The recess 52 opens upwards and opposes the turntable 27 of the disk-driving unit 25. The rotor support 51 has a through hole 53 made in the approximately center of the recess 52. A rotor 55 is mounted in the recess 52 and can rotate. The rotor 55 is shaped like a disk. The outer circumference of the rotor 55 is capable to attach to the inner surface of the through hole 53. A magnetic member (not shown), for example, a metal plate, is secured to the rotor 55. The rotor 55 cooperates with the turntable 27 to clamp the optical disk 28, by virtue of the magnetic force of a magnet 29 that is embedded in the distal end of the shaft 27a of the turntable 27.

The frame 11 holds a disk tray 61. The disk tray 61 can move back and forth in a horizontal plane, sliding on the support ribs 11c inside the frame 11.

The disk tray 61 has an approximately rectangular tray 62 made of, for example, synthetic resin. The tray 62 has an opening that exposes the disk-driving unit 25 and the data-reproducing unit 41 of the main unit 20.

The tray 62 has a circular recess 62a in one end in longitudinal direction. The recess 62a opens upwards, for holding the optical disk 28. A window-closing plate 65 is detachably attached to that one of the tray 62 in longitudinal direction. The window-closing plate 65 is made of the same material as the decorative panel 5. The plate 65 closes the window 5a that is made in the decorative panel 5.

A shutter-driving unit 71 is arranged in the frame 11, at the shutter drive-holding rib 11d.

The shutter-driving unit 71 has a transmission pulley 72, a transmission gear 73, and a driven gear 74. The pulley 72 is rotatably held on the shutter-drive holding rib 11d. The gear 73 is set in engagement with the transmission pulley 72. The driven gear 74 is in mesh with the transmission gear 73 and set in engagement with the disk tray 61.

The shutter-driving unit 71 includes an electric motor 75. A pulley 76 is mounted on an output shaft 75a of the motor 75. An endless belt 77 is wrapped around the pulley 76 and the transmission pulley 72. When the motor 75 is driven, the pulley 76, the transmission pulley 72, the transmission gear 73 and the driven gear 74 rotate, thereby moving the disk tray 61.

The disk-driving unit 25, the drive unit 31, the data-reproducing unit 41 and the shutter-driving unit 71 constitute the main unit 20.

The circuit board 81 is mounted on the frame 11.

The above-mentioned circuit board 81 is detachably fastened to the frame 11, by means of fastening claws (not shown) that are provided on the frame 11. The circuit board 81 is a rectangular plate that has almost the same size as the lower case 4 of the outer case 2. It closes the lower edge of the frame 11, thus covering the main unit 20. Though not shown, a control circuit having the electric component 82 and designed to control the main unit 20 is mounted on the circuit board 81.

The circuit board 81 has a through hole 83. The through hole 83 defines a heat passage that conducts the heat generated by the electric component 82, to the cooling fan (not shown) in the state that the circuit board 81 is mounted on the frame 11.

Connectors 85 are mounted on the circuit board 81. Power lines and cables for supplying signals to and from external electric devices are detachably connected to the connectors 85, respectively.

As FIG. 4 shows, the connectors 85 are arranged at the rear wall 11b of the frame 11, exposed outside through the opening 4c of the outer case 2.

The connectors 85 of different types are juxtaposed in the horizontal direction. Data items 85a about the connectors 85 (e.g., the types of the cables that are to be connected to the connectors 85) are indicated on the surface of the rear wall 3c.

The data items 85a may be engraved in the parts of the rear wall 3c which lie above the connectors 85. Alternatively, labels with the data items 85a indicated thereon may be adhered to the rear wall 3c.

[Method of Manufacturing Disk Drive]

A method of manufacturing the outer case 2 of the disk drive according to the embodiment will be described.

First, a rectangular metal plate shown in FIG. 5 and having length N1 and width N2 is prepared to manufacture the upper case 3. The metal plate is cut into the predetermined profile by means of a press or the like. The data items 85a may be formed at the same time the metal plate is pressed.

Then, the metal plate is bent along the dashed lines (FIG. 5), forming the upper case 3 that is shaped like a box. The lower case 4 is made in the same manner as the upper case 3.

After the upper case 3 and lower case 4 are thus made, the main unit 20 and the circuit board 81, both manufactured beforehand, are secured to the frame 11. The frame 11 is fastened to the lower case 4. The upper case 3 is fastened to the frame 11 to cover the main unit 20.

[Advantages of Disk Drive]

(1) The disk drive 1 includes the main unit 20 and the outer case 2 covering the main unit 20. The main unit 20 has the disk-driving unit 25 for rotating the disk 28, the data-reproducing unit 41 for reproducing data from the disk 28, and the drive unit 31 for moving the data-reproducing unit 41 relative to the optical disk 28. The outer case 2 includes the top wall 3a and the rear wall 3c. The top wall opposes the main unit 20. The rear wall 3c extends from the rear edge of the top wall 3a, is gently inclined and covers the back of the main unit 20. Gently inclined, the rear wall 3c serves as a guide when the disk drive 1 is inserted into a tower-type computer through a slot made in one side of the computer. Thus, the disk drive 1 can be smoothly inserted into the computer to prevent the disk drive 1 or the slot, or both, from being damaged.

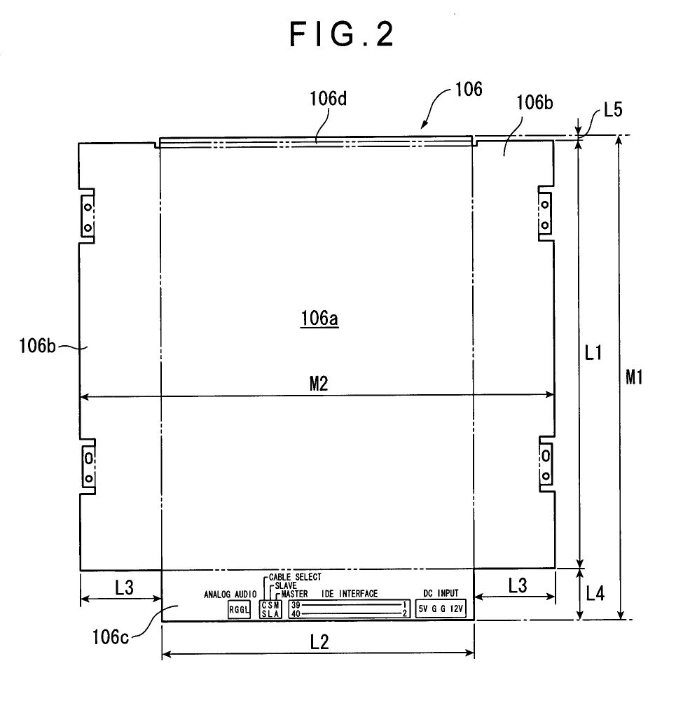

Further, the metal plate shown in FIG. 5 and having length N1 and width N2, which is bent to form the upper case 3 that has the top wall 3a and the rear wall 3c inclined, is relatively small, thereby decreasing not only the manufacturing cost of the disk drive 1, but also reduces the weight of the disk drive 1. That is, the metal plate has the width N2 equal to the width M2 (2×L3+L2) of the case shown in FIG. 2, but its length N1 is N3 less than the length M1 of the case shown in FIG. 2. Thus, the metal plate is smaller than the metal plate of FIG. 2 by an area of N3×N2.

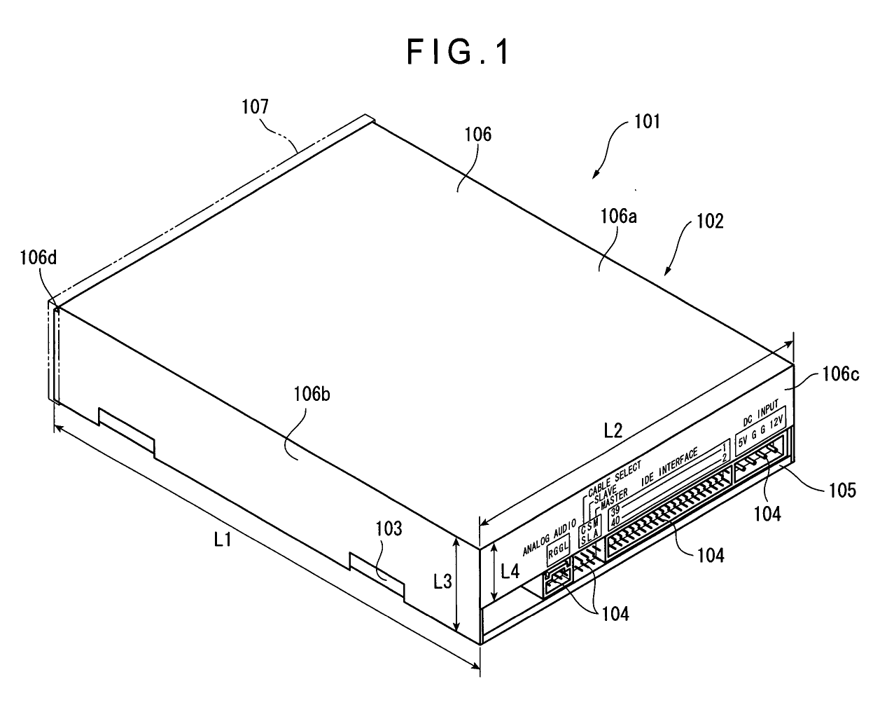

(2) The main unit 20 has the connectors 85 to which cables are detachably connected to supply power and signals to the disk drive 1 from an external apparatus, and vice versa. The data items 85a indicating the data about the connectors 85 are provided on the surface of the rear wall 3c that is inclined and located near the connectors 85. The user can, therefore, clearly read the data items 85a even if the user looks at the rear wall 3c slantwise from above when the user inserts the disk drive 1 into the slot of the computer. This facilitates the insertion of the disk drive 1 into the slot. By contrast, the data items provided on the rear wall 106c of the conventional disk drive 101 as shown in FIGS. 1 and 2, cannot be clearly read unless the user looks straight at the rear wall 106c. This is because the rear wall 106c extends from the rear edge of the top wall 106a at right angles thereto. Consequently, it is troublesome for the user to insert the drive 101 into the slot of a computer.

(3) The upper case 3 of the outer case 2 has the top wall 3a, from which the rear wall 3c extends downward and slantwise. The user can therefore clearly see the data items 85a from above.

(4) The rear wall 3c, which is a flat plate, is inclined. Hence, it has a greater area than if it extends vertically. This makes it easy to provide the data items 85a on the rear wall 3c and renders it possible to present the data items 85a in larger size. As a result, the data items 85a can be read more clearly than otherwise. In addition, the top wall 3a and the rear wall 3c can be defined by bending the metal plate only once. Thus, the upper case 3 is easy to make.

(5) The outer case 2 includes the upper case 3 and the lower case 4 that are joined together. Since the upper case 3 and lower case 4 are shaped like a box and a flat plate, respectively, the junction between them lies near the bottom of the disk drive 1. This imparts a good outer appearance to the disk drive 1.

[Modification of Embodiment]

Incidentally, the scope of the present invention is not restricted to the above specific embodiment, but includes below-described modifications as long as an object of the present invention can be attained.

In the embodiment described above, the rear wall 3c is a flat plate. Nonetheless, it may be assume any other shape so long as the rear wall 3c is inclined at the rear edge thereof as a whole. For example, the rear wall 3c may be bent in midcourse thereof as shown in FIG. 6B. Alternatively, the rear wall 3c may be curved as shown in FIG. 6C, rounding the rear-upper edge of the outer case 2 and thus imparting a better outer appearance to the disk drive 1.

In the present invention, since the connectors 85 are provided on the top of the disk drive 1, the rear wall 3c can be integrally formed with the lower case 4 as an inclined rear wall. As a result, the data items 85a will be well seen from below.

The disk drive 1 of the present invention is not limited to one designed to reproduce data from optical disks 28. Rather, other types of disks can be used for recording and reproducing data thereon and thereby in an optical or magnetic manner.

The disk drive 1 described above has the disk tray 61 that is moved by the shutter-driving unit 71. Nevertheless, the disk tray 61 can be dispensed with. If this is the case, a carriage having a rotating member may be provided in the outer case 2 to load and eject the optical disk 28 into and from the outer case 2 through the rectangular window 5a made in the decorative panel 5. Alternatively, the disk may be rotatably held in a case, such as MD (mini disk), which is directly inserted into and ejected from the window 5a. Alternatively, the optical disk may be held in a prescribed case, which is inserted into and ejected from the case. Still alternatively, the shutter-driving unit 71 may not be provided, and the upper case 3 of the outer case 2 may be rotated to cover the main unit 20 from above after the disk is placed at a prescribed position.

In the embodiment described above, the entire frame 11 is held in the outer case 2 that is shaped like a box for covering whole. Instead, only at least one part of the frame 11 may expose from the outer case 2. Alternatively, only least one part of the frame may be held in the frame 11, with another part constituting the outer case 2, covering the main unit 20 and, thus, preventing the same from being exposed.

What is claimed is:

1. A disk drive comprising:
a main unit which comprises a disk-driving unit for rotating a disk, a data-reproducing unit for reproducing data from the disk, and a drive unit for moving the data-reproducing unit relative to the disk; and
an outer case which has a horizontal plate opposing the main unit and an inclined plate extending from a rear edge of the horizontal plate, gently inclining and covering the rear part of the main unit.

2. The disk drive according to claim 1, wherein the main unit comprises connectors to which cables are to be detachably connected for supplying power and signals to the disk drive from external apparatuses and vice versa, the inclined plate is located in the vicinity of the connectors, and data items about the connectors are indicated on the inclined plate.

3. The disk drive according to claim 1, wherein the horizontal plate is a top wall which covers the main unit from above, the inclined plate has been formed by bending downward a plate which is integral with the horizontal plate.

4. The disk drive according to claim 1, wherein the inclined plate is a flat plate.
